(19) United States
(12) Patent Application Publication
(10) Pub. No.: US 2025/0165810 A1
(43) Pub. Date: May 22, 2025

(54) METHOD AND SYSTEM OF CREATING BALANCED DATASET

(71) Applicant: L&T TECHNOLOGY SERVICES LIMITED, Chennai (IN)

(72) Inventors: SWAROOP KUMAR MYSORE LOKESH, Mysore (IN); NAGA AKHIL ETCHERLA SRIDHAR, Bengaluru (IN); PRERNA AGRAWAL, Bhagalpur (IN); ASHOK AJAD, Gorakhpur (IN)

(21) Appl. No.: 18/116,859

(22) PCT Filed: Dec. 1, 2022
(86) PCT No.: PCT/IB2022/061630

§ 371 Date: Mar. 3, 2023

(30) Foreign Application Priority Data
Aug. 11, 2022 (IN) 202241045837

(51) Int. Cl. G06N 5/022; G06F 16/906

(52) U.S. Cl. CPC G06N 5/022; G06F 16/906

(57) ABSTRACT

A method and system of creating balanced dataset is disclosed that includes receiving an input dataset having data-file. Each data-file comprises attribute values corresponding to a plurality of attributes. A bucket dataset is created by selection of data-file from the dataset having highest first selection value. Iterative sampling is performed to determine a subset of the dataset including subset data which is determined based on summation data file. The summation data-file is determined by summing the attribute values for the attributes. The summation data-file for each iteration is added to a summation dataset. Second selection value is determined for each subset data based on probability of occurrence of each attribute in each subset data. Bucket dataset is updated to include image data corresponding to subset based on subset data having highest second selection value. The balanced dataset is determined based on an output criterion based on a third selection value.

### TECHNICAL FIELD

This disclosure relates generally to data processing and machine learning, and more particularly to a system and a method for creating balanced datasets by using data processing methods in machine learning.

### BACKGROUND

Artificial Intelligence is utilized for various purposes such as speech recognition, chatbots, etc. These utilize machine learning algorithms which are further trained using training data. Type of training data depends upon the purpose and type of ML models. A large volume of data may be utilized for preparing the training data. The data is generally classified based on various attributes. The volume of data collected is annotated based on various attributes in accordance with the attribute present like words spoken in an audio recording, photos containing specific attributes such as rivers, mountains, or trees, etc. In machine learning, training data in form of classified datasets are used to train the ML model to provide accurate results. However, an unbalanced class distribution in the dataset can falsify the outcomes of the machine learning algorithm due to biases. Imbalanced class distribution in a dataset involves unequal class wise distribution of data. Many machine learning algorithms rely upon the class distribution in the training dataset to gauge the likelihood of observing examples in each class when the model will be used to make predictions.

Therefore, there is requirement to generate balanced datasets for training the machine learning algorithms in order for them to provide optimum results.

### SUMMARY OF THE INVENTION

In an embodiment, a method for creating a balanced dataset is provided. The method may include receiving, by a computing device comprising one or more processors, a dataset comprising a plurality of input data files which may further comprise of attribute values corresponding to a presence of a plurality of attributes. In an embodiment, the input data file may also be associated with a counter value. The computing device may further create a bucket dataset based on a highest first selection value which may be a quantification value corresponding to each of the input data files, further determined based on a probability of occurrence of each attribute from the input data file. The dataset is iteratively sampled to create a subset dataset including subset data files, wherein subset data files are determined based on a summation data file. The summation data file is determined based on summation of attribute values for each of the attributes for each of the input data file of the bucket dataset. The summation data file is added to the summation dataset. A second selection value is determined for each of the subset data files of the subset dataset, wherein the second selection value is a quantification value of each the subset data files determined based on probability of occurrence of each of the attributes in each of the corresponding subset data file. The input data file of the updated dataset corresponding to the subset data file with highest second selection value is added to the bucket dataset and the dataset is updated by decrementing the input data file added to the bucket dataset. A third selection value is determined for each of the summation data files of the summation dataset and the output dataset is determined as the bucket dataset determined for the sampling iteration based on an output criterion. The output criterion is based on the third selection value.

In another embodiment, a system of creating an output dataset comprising one or more processors in a data processing device communicably connected to a memory, wherein the memory stores a plurality of processor-executable instructions which upon execution cause the one or more processors to receive a dataset comprising a plurality of input data files. The input data files may comprise of attribute values corresponding to a presence of a plurality of attributes. In an embodiment, the input data file may also be associated with a counter value. The one or more processors may further create a bucket dataset based on a highest first selection value which may be a quantification value corresponding to each of the input data files, further determined based on a probability of occurrence of each attribute from the input data file. The dataset is iteratively sampled to create a subset dataset including subset data files, wherein subset data files are determined based on a summation data file. The summation data file is determined based on summation of attribute values for each of the attributes for each of the input data file of the bucket dataset. The summation data file is added to the summation dataset. A second selection value is determined for each of the subset data files of the subset dataset, wherein the second selection value is a quantification value of each the subset data files determined based on probability of occurrence of each of the attributes in each of the corresponding subset data file. The input data file of the updated dataset corresponding to the subset data file with highest second selection value is added to the bucket dataset and the dataset is updated by decrementing the input data file added to the bucket dataset. A third selection value is determined for each of the summation data files of the summation dataset and the output dataset is determined as the bucket dataset determined for the sampling iteration based on an output criterion. The output criterion is based on the third selection value.

In yet another embodiment, a method of creating an output dataset is disclosed in which one or more processors of a computing device receive a dataset from a plurality of data sources. The dataset may comprise a plurality of input data files, wherein each input data file from the plurality of input data files may comprise one or more pre-defined attributes. The dataset may be iteratively sampled based on a pre-defined type of sampling and the output dataset may be determined based on the pre-defined type of sampling and an output criterion associated to the pre-defined type of sampling. The output dataset may comprise a threshold number of input data files and a threshold value of distribution of the input data files for each of the pre-defined attributes.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of a data processing system for generating balanced datasets, in accordance with an embodiment of the present disclosure.

FIG. 2 is a flowchart depicting a methodology of creating a balanced dataset for a plurality of pre-defined attributes, in accordance with an embodiment of the present disclosure.

FIG. 3 is an exemplary embodiment depicting initial configuration for the methodology of creating a balanced dataset from an unbalanced input dataset as defined in FIG. 2, in accordance with an embodiment of the present disclosure.

FIG. 4A-B is an exemplary embodiment depicting the methodology of the creation of the balanced dataset from an unbalanced input dataset using under-sampling as described in FIG. 2, in accordance with an embodiment of the present disclosure.

FIG. 5 is an exemplary standard deviation graph generated for an exemplary embodiment, in accordance with an embodiment of the present disclosure.

FIG. 6 is an exemplary embodiment depicting the methodology of creation of the balanced dataset from an unbalanced input dataset using per-class balancing as described in FIG. 2, in accordance with an embodiment of the present disclosure.

FIG. 7 is an exemplary embodiment depicting the methodology of creation of the balanced dataset from an unbalanced input dataset using targeted sampling as described in accordance with FIG. 2, in accordance with an embodiment of the present disclosure.

FIG. 8 is an exemplary embodiment depicting the methodology of creation of the balanced dataset from an unbalanced input dataset using over-sampling as described in accordance with FIG. 2, in accordance with an embodiment of the present disclosure.

FIG. 9 is a flowchart of a method of creating an output dataset, in accordance with an embodiment of the present disclosure.

### DETAILED DESCRIPTION OF THE DRAWINGS

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the scope of the disclosed embodiments. It is intended that the following detailed description be considered as exemplary only, with the true scope being indicated by the following claims. Additional illustrative embodiments are listed.

Presently, data sampling is performed in accordance to the type of data available and the requirement and purpose of use of the dataset. In machine learning, training data in form of classification datasets are used. However, an unbalanced class distribution in the dataset can falsify the outcomes of the machine learning algorithm due to biases. Imbalanced class distribution in a dataset involves unequal class wise distribution of data. Many machine learning algorithms rely upon the class distribution in the training dataset to gauge the likelihood of observing examples in each class when the model will be used to make predictions. Therefore, there is requirement to generate balanced datasets for training the machine learning algorithms in order for them to provide optimum results. Different types of data sampling methods are used for data preparation as per requirement of the model and also based on the type of data available.

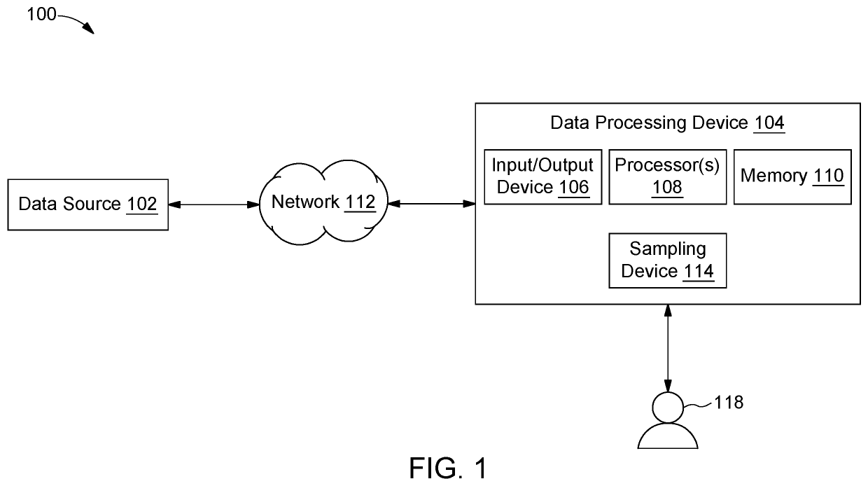

The present disclosure provides methods and systems for generating balanced datasets for an unbalanced data input. FIG. 1 is a block diagram of a data processing system 100 for generating balanced datasets, in accordance with an embodiment of the present disclosure. By way of an example, a data source 102 may be communicatively coupled to a data processing device 104 through a network 112. In an embodiment, the data source 102 may be a database enabled in cloud or a physical database. In an embodiment, the data source 102 may be a paid subscription-based database from which data corresponding to the requirement may be received.

In an embodiment, the data processing device 104 may be communicatively coupled to the data source 102 through a wireless or wired communication network 112. In an embodiment, a user 118 may be a data scientist or a programmer using the data processing device 102 via a user device (not shown). In an embodiment, user devices (not shown) can include a variety of computing systems, including but not limited to, a laptop computer, a desktop computer, a notebook, a workstation, a portable computer, a personal digital assistant, a handheld or a mobile device. In an embodiment, the data processing device 104 may be in-built into the user device.

In an embodiment, the user 118 may be authenticated by the data processing device 104 based on input of one or more authentication information including user-name and password. In an embodiment, the user 118 may be provided access to the data processing device 104 based on authorization of the inputted authentication information.

The data processing device 104 may include a processor 108 and a memory 110. In an embodiment, examples of processor 108 may include, but are not limited to, an Intel® Itanium® or Itanium 2 processor(s), or AMD® Opteron® or Athlon MP® processor(s), Motorola® lines of processors, FortiSOC™ system on a chip processors or other future processors. The memory 110 may store instructions that, when executed by the processor 108, cause the processor 108 to create a balanced dataset, as discussed in greater detail below. The memory 110 may be a non-volatile memory or a volatile memory. Examples of non-volatile memory may include, but are not limited to a flash memory, a Read Only Memory (ROM), a Programmable ROM (PROM), Erasable PROM (EPROM), and Electrically EPROM (EEPROM) memory.

Examples of volatile memory may include but are not limited to Dynamic Random Access Memory (DRAM), and Static Random-Access memory (SRAM). The memory 110 may also store one or more machine learning algorithms which are to be trained using the created balanced dataset.

In an embodiment, the communication network 112 may be a wired or a wireless network or a combination thereof. The network 112 can be implemented as one of the different types of networks, such as but not limited to, ethernetIP network, intranet, local area network (LAN), wide area network (WAN), the internet, Wi-Fi, LTE network, CDMA network, and the like. Further, the network 112 can either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 112 can include a variety of network devices, including routers, bridges, servers, computing devices, storage devices, and the like.

In an embodiment, the data received from the data source 102 is classified based on a plurality of classes or labels defined by the user 118. In an embodiment, the classes may be pre-defined or automatically determined using one or more classification algorithms. The data processing device 104 may determine a user input regarding the type of data sampling to be performed and may configure a sampling device 114 to sample the input data based on the inputted parameters and requirement by the user. In an embodiment, the sampling device 114 may implement one or more data processing algorithms to perform the sampling of the input data based on user input. In an embodiment, the types of sampling which the sampling device 114 may perform includes but not limited to, under-sampling, per-class sampling, targeted sampling and/or oversampling.

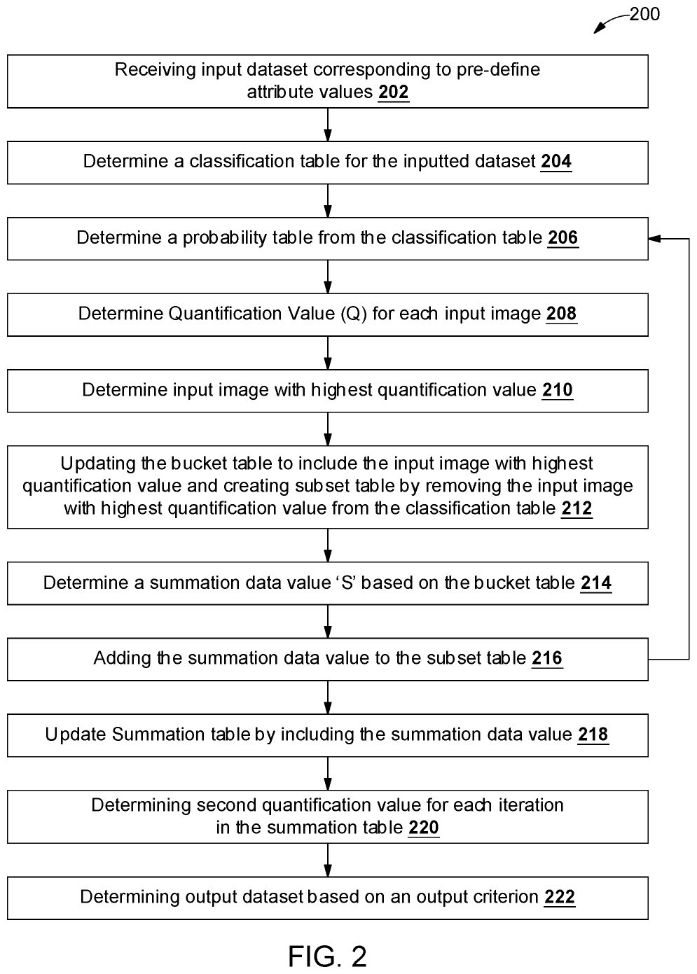

FIG. 2 is a flowchart 200 depicting a methodology of creating a balanced dataset from an unbalanced input dataset, in accordance with an embodiment of the present disclosure.

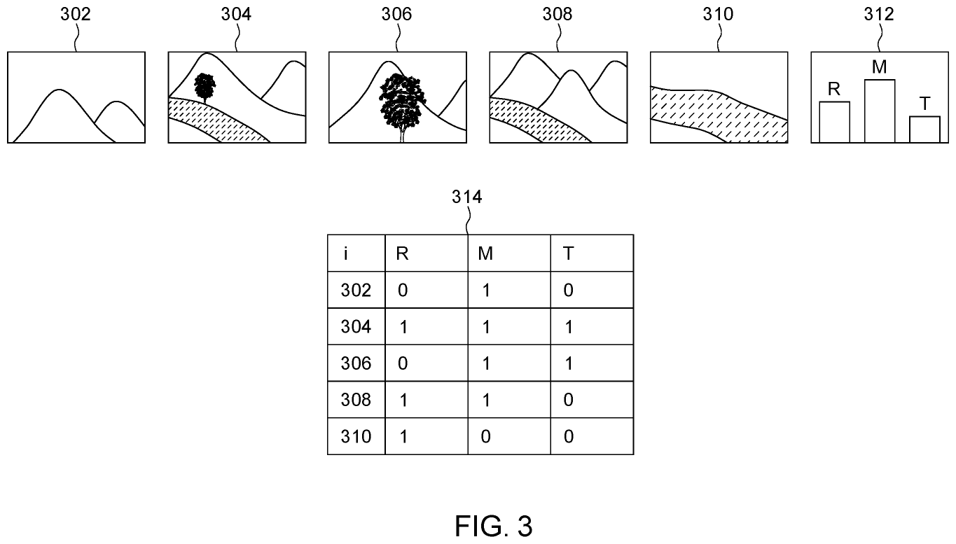

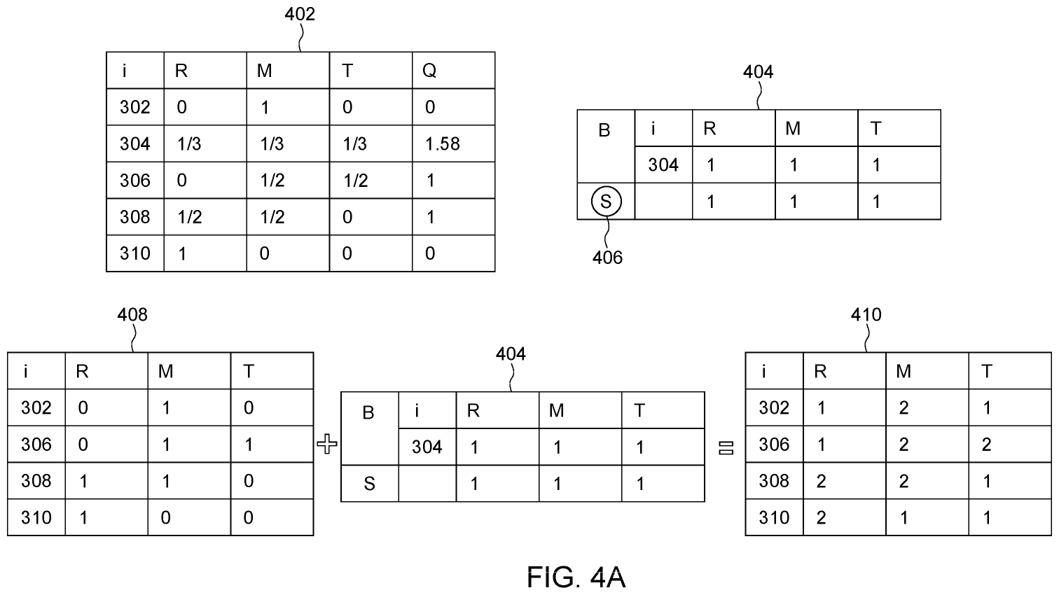

FIG. 3 is an exemplary embodiment depicting initial configuration for the methodology of creating a balanced dataset from an unbalanced input dataset as defined in FIG. 2, in accordance with an embodiment of the present disclosure.

At step 202, an input dataset corresponding to a plurality of pre-defined attributes is received from the data source 120 by the sampling device 114. The sampling device 114 may then perform data sampling as per the inputted requirements of the user 118. In an embodiment, the user input regarding the classification and data type or any other information may be inputted by the user 118 via a user interface of a user device (not shown).

In an embodiment, under-sampling may be performed to generate a balanced dataset. FIG. 3 shows images 302-310 as an exemplary data input received from the data source 102 corresponding to pre-defined attribute values. For ease of explanation, the methodology is described using an input data comprising 5 images 302-310 corresponding to 3 pre-defined attributes, including river (R), mountain (M) and trees (T). In an embodiment, the data inputted may include higher number of images such as but not limited to, in thousands or millions, etc. corresponding to the pre-defined attributes. At step 204, the inputted images 302-310 is classified to create a classification table 314 in accordance with three predefined attributes namely River (R), Mountains (M) and Trees (T). In an embodiment, each image may be processed to determine if it contains any of the pre-defined attributes based on image processing algorithms known in the art. In an embodiment, the characterization of the data may be done using appropriate processing algorithms based on the type of data and requirements. Based on the image processing, it may be determined if the dataset is balanced or not based on a number of images comprising each attribute as shown in graphical representation 312. Accordingly, the classification table 314 is generated which depicts presence and absence of an attribute in each image by using ‘1’ and ‘0’ respectively. The distribution graph 312 is created to understand the distribution of images based on each attribute. Therefore, it may be determined that the input dataset comprising images 302-310 is not balanced as it has maximum number of images which have mountain (M) attribute, followed by river (R) and tree (T) attributes as shown in distribution graph 312. Accordingly, to achieve a balanced dataset the attribute wise distribution of images is required to achieve a balanced dataset. In a balanced dataset each attribute may be represented by almost same number of data. This may be required in order to prevent biasing of the Machine Learning (ML) algorithm. Accordingly, different types of sampling methods may be used to determine a balanced dataset based on different methodologies.

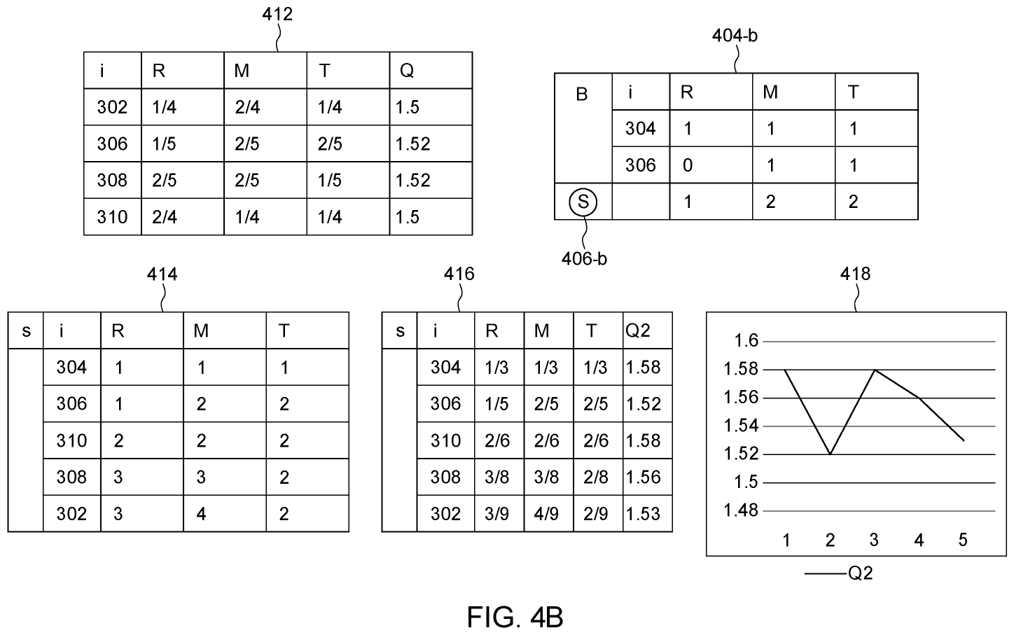

FIG. 4A-B is an exemplary embodiment depicting a methodology of creating balanced dataset from an unbalanced dataset using under-sampling as described in FIG. 2, in accordance with an embodiment of the present disclosure.

At step 206, a probability table 402 is determined from the input classification table 314. The probability table 402 as shown in FIG. 4A is generated by determining a probability of occurrence of each of the attributes for each input image 302-310. At step 208, a quantification value ‘Q’ for each input image 303-310 is determined based on a formula given by equation (1).

Equation (1)—Q=Σᵢpᵢ log₂(1/pᵢ), wherein ‘pᵢ’ is the probability of attribute. In an embodiment, equation (1) may be based on natural log. At step 210, based on the determination of the quantification value ‘Q’, the image with highest quantification value is selected or bucketed in a bucket table. Accordingly, at step 212, in accordance with the exemplary embodiment, the image 304 is added to the bucket table 404 as shown in FIG. 4A. Also, the classification table which may also be referred to as input table 314 is updated to remove the image 304 having highest quantification value. Accordingly, the image 304 which is determined to have the highest ‘Q’ value is removed from the input table to determine a subset table 408. At step 214, the summation data value ‘S’ 406 is determined based on the bucket table 404 determined. The summation data value ‘S’ 406 may be determined by summing the attribute values of all attributes for all the images in the bucket table 404. At step 216, the summation data value 406 is added to the subset table 408 to determine an intermediary subset table 410. Accordingly, the process may move back to step 206 based on which probability table 412 as shown in FIG. 4B is generated including probability value for all the attributes that may be determined for each image in the intermediary subset table 410. Based on which quantification value using equation (1) may be determined for each image in the probability table 412 at step 208 as shown in table 412 of FIG. 4B. The image with highest quantification value ‘Q’ may be determined at step 210. In an embodiment, the image with highest quantification value coming first in the precedence may be selected in case more than one images have highest quantification value. The bucket table 404 is updated as 404-b at step 212 to add the image 306 determined to have a highest quantification value to it. Also, the input table 314 is updated to remove the image with highest quantification value at step 212 to generate a subset input table (not shown). At next step 214, the updated summation value 406-b may be determined based on the updated bucket table 404-b. The updated summation value 406-b may be added to the subset input table to determine an updated intermediary subset table 410. Thus, an iterative sampling is done based on the updated intermediary subset table 410 to determine updated bucket table 404-b for each iteration in order to determine a balanced dataset. The iteration may be performed until all the input images in the input table are added to the bucket table.

At step 218, a summation table is created by including the summation data value obtained in each iteration in the summation table 414. At step 220, a second quantification value ‘Q2’ is determined for each iteration based on probability determination of each attribute in the summation table for each iteration as shown in 416. In an embodiment, the Q2 may be used to determine the standard deviation using an equation (3).

Equation (3)—Q2=1/n Σᵢ(pᵢ−pₘ)², wherein n is the number of attributes and pᵢ is probability of the attribute and pₘ is the mean of values of attribute probabilities of a single data file.

At step 222, an output balanced dataset is determined based on a pre-defined output criterion. In an embodiment, when sampling type is selected as under-sampling, the output criterion for determining the balanced dataset is based on determining a bucket table 404 generated for an iteration for which the standard deviation is least as shown in a standard deviation graph 418. The standard deviation graph 418 may be plotted based on number of iteration v. second quantification value of each iteration. Also, the bucket table 404 which comprises a threshold number of images is determined as the output. For example, for first iteration the bucket table 404 includes just one image 304 which provides balanced class distribution, however, this bucket is not considered as output dataset as the number of images in the bucket table 404 is not sufficient to meet the threshold level. In an embodiment, the threshold may be selected by the user based on the standard deviation graph 418. In an embodiment, the bucket table which has a threshold value of distribution of the input data files for each of the pre-defined attributes may be selected as the output dataset.

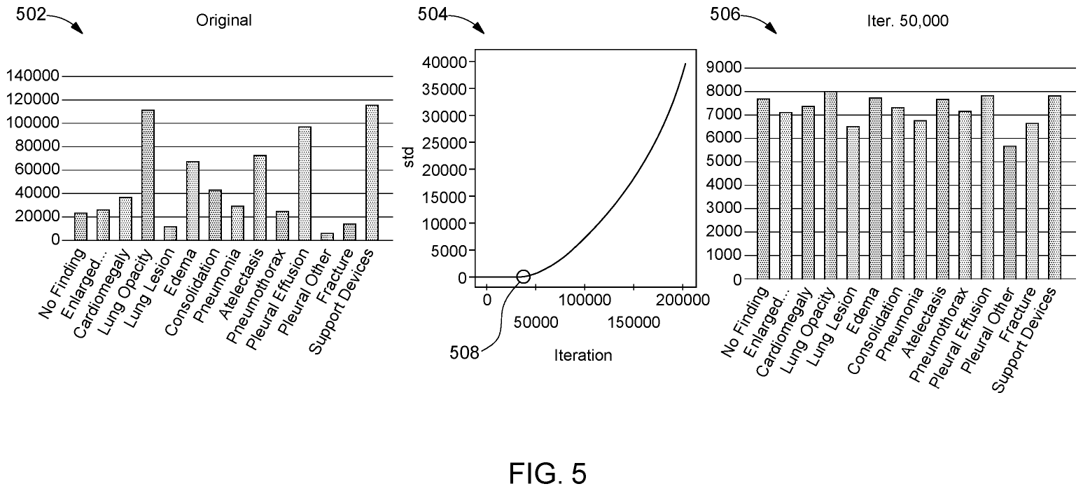

FIG. 5 illustrates an exemplary standard deviation graph 418 generated for an exemplary embodiment, in accordance with an embodiment of the present disclosure. A distribution graph 502 of an exemplary input dataset comprising approximately 120,000 images corresponding to fourteen classifications is shown. may be inferred from the distribution graph 502 the per class distribution is unbalanced and has very few images corresponding to few classes such as ‘fracture’ and ‘pleural other’. Further, it may be seen that the graph 504 plotted based on iteration number vs. standard deviation of each bucket dataset for each iteration becomes non-linear after a point 508 as shown. Therefore, the most balanced output dataset 506 may be determined around the point 508 for 50,000th iteration approximately.

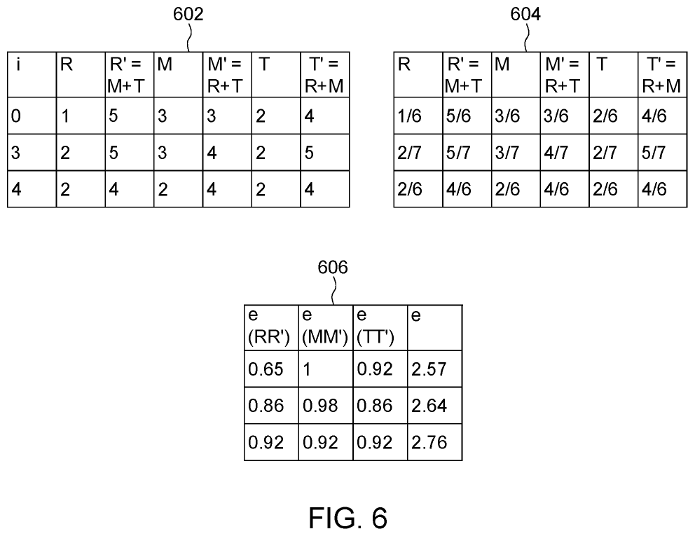

FIG. 6 is an exemplary embodiment depicting the methodology of creation of the balanced dataset from an unbalanced input dataset using per-class balancing as described in FIG. 2, in accordance with an embodiment of the present disclosure. An intermediary subset table 602 is determined similarly to the intermediary subset table 410 of FIG. 4A during sampling. The intermediary subset table 602 includes determination of both presence and absence of attributes for each image. For example, for image 302 the instance of presence of river is 1, however the instance for absence of river is 5 based on a total of all instances for each attribute for image 302 which is determined as 6. Further, probability table 604 for each image is determined to provide probability of presence and absence of each attribute based on the intermediary subset table 602 created for the present embodiment. Accordingly, a quantification value ‘Q’ 606 is determined for each image based on the sum of quantification value determined using equation (1) each for presence and absence of each attribute for each image data. Further, the row with highest quantification value is selected and added to the bucket table 404 for each iteration. The output criterion for determining the per-class balanced dataset is based on the bucket table with maximum value of sum of quantification values of each attributes of each image.

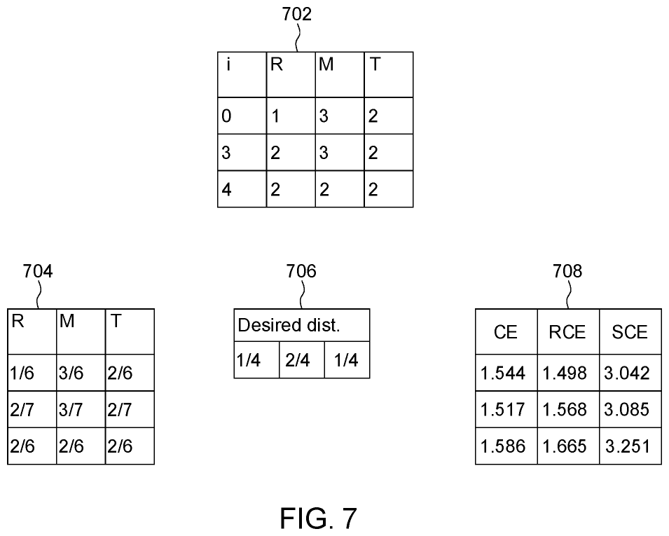

FIG. 7 is an exemplary embodiment depicting the methodology of creation of the balanced dataset from an unbalanced input dataset using targeted sampling as described in accordance with FIG. 2, in accordance with an embodiment of the present disclosure.

An intermediary subset table 702 is determined similarly to the intermediary subset table 410 of FIG. 4A during sampling. A probability table 704 is determined from the intermediary subset table 702. A desired target distribution 706 is pre-defined by the user 118 based on which the distribution of the output dataset is determined. In an exemplary embodiment, the desired target distribution 706 may vary from one case to another. Accordingly, a second quantification value ‘Q’ which may be defined as symmetric cross entropy and is sum of cross entropy and reverse cross entropy is determined using a formula given by equation (2).

Equation (2)—Q=Σdᵢ log(1/pᵢ)+Σpᵢ log(1/dᵢ) wherein pᵢ is the probability of an attribute and dᵢ is the desired distribution inputted by the user 118 for each attribute. Based on the determination of the quantification value ‘Q’ the image with least quantification value is selected to be added to the bucket table. Further, the output dataset as per targeted sampling is determined based on pre-defined output criterion. Based on the output criterion, the output dataset is selected based on the bucket table for which the second quantification value is minimum. In an embodiment, the quantification value may be referred to as entropy or standard deviation throughout the disclosure. Further, the output criterion may be determined based on other factors as well.

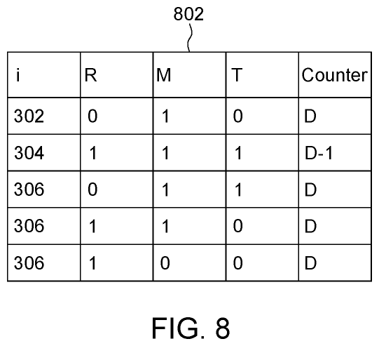

FIG. 8 is an exemplary embodiment depicting the methodology of creation of the balanced dataset from an unbalanced input dataset using over-sampling as described in accordance with FIG. 2, in accordance with an embodiment of the present disclosure. The characteristic table 314 of FIG. 3 is modified to include a counter value assigned to each image as shown in 802. Accordingly, step 210 of FIG. 2 is modified to determine an image with highest quantification value ‘Q’ and highest counter value ‘C’. In an embodiment, the counter value may be pre-defined by a user 118 based on the maximum number of duplicates of data is to be created in the output dataset. This may be done when there is lack of data corresponding to an attribute and to create a balanced dataset the data with the corresponding attribute may be duplicated to prevent biasing of the ML model. Further, the step 212 of FIG. 2 is modified in which the subset input table is created by decrementing the counter of the image which is added to the bucket in each iteration. The image may be removed entirely from the subset input table in case the counter for that image becomes zero. Accordingly, an image may be selected and added to the bucket table a number of times as defined by the counter value ‘C’. Further, the output dataset is determined based on pre-defined output criterion as described in FIG. 2. Accordingly, the criterion for determining the dataset with desired distribution is based on determining a bucket dataset corresponding to the bucket table created for which the standard deviation is least as shown in a standard deviation graph 418 plotted based on number of iteration v. second quantification value of each iteration. Also, the bucket dataset which comprises a threshold number of images is determined as the output.

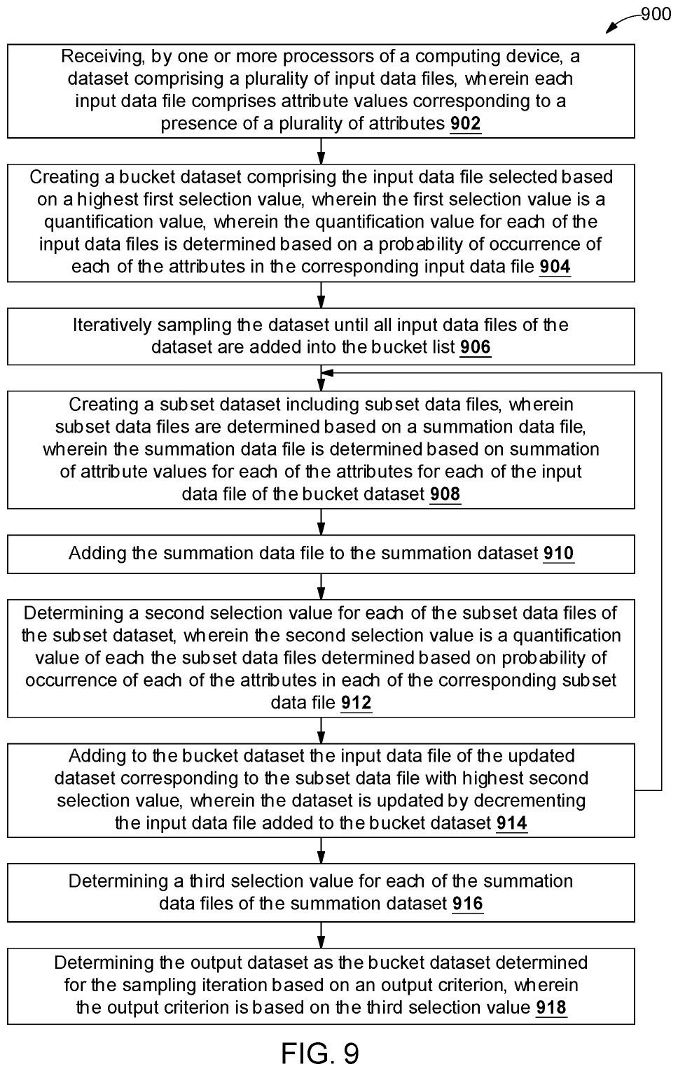

FIG. 9 is a flowchart 900 of a method of creating an output dataset, in accordance with an embodiment of the present disclosure. At step 902, a dataset comprising a plurality of input data files is received. The input data files may comprise of attribute values corresponding to a presence of a plurality of attributes. At step 904, a bucket dataset may be created based on a highest first selection value which may be a quantification value corresponding to each of the input data files. The first selection value may be determined based on a probability of occurrence of each attribute from the input data file. At step 906, the input dataset may be iteratively sampled until all input data files of the input are added to the bucket list. At step 908, a subset dataset may be created including subset data files, wherein subset data files are determined based on a summation data file. The summation data file may be determined based on summation of attribute values for each of the attributes for each of the input data file of the bucket dataset. At step 910, the summation data file may be added to the summation dataset. At step 912, a second selection value may be determined for each of the subset data files of the subset dataset, wherein the second selection value is a quantification value of each the subset data files determined based on probability of occurrence of each of the attributes in each of the corresponding subset data file. At step 914, the input data file of the updated input dataset corresponding to the subset data file with highest second selection value is added to the bucket dataset and the subset input dataset is updated by decrementing the input data file added to the bucket dataset. At step 916, a third selection value may be determined for each of the summation data files of the summation dataset. At step 918, the output dataset may be determined as the bucket dataset determined for the sampling iteration based on an output criterion, wherein the output criterion is based on the third selection value.

It is intended that the disclosure and examples be considered as exemplary only, with a true scope of disclosed embodiments being indicated by the following claims.

What is claimed is:

1. A method of creating an output dataset, the method comprising:
receiving, by one or more processors of a computing device, a dataset comprising a plurality of input data files,
wherein each input data file comprises attribute values corresponding to a presence of a plurality of attributes;
creating a bucket dataset comprising the input data file selected based on a highest first selection value, wherein the first selection value is a quantification value, wherein the quantification value for each of the input data files is determined based on a probability of occurrence of each of the attributes in the corresponding input data file;
iteratively sampling the dataset until all input data files of the dataset are added into the bucket list, wherein the iterative sampling for each iteration comprises:
creating a subset dataset including subset data files, wherein subset data files are determined based on a summation data file, wherein the summation data file is determined based on summation of attribute values for each of the attributes for each of the input data file of the bucket dataset;
adding the summation data file to the summation dataset;
determining a second selection value for each of the subset data files of the subset dataset, wherein the second selection value is a quantification value of each the subset data files determined based on probability of occurrence of each of the attributes in each of the corresponding subset data file; and
adding to the bucket dataset the input data file of the updated dataset corresponding to the subset data file with highest second selection value, wherein the dataset is updated by decrementing the input data file added to the bucket dataset;
determining a third selection value for each of the summation data files of the summation dataset; and
determining the output dataset as the bucket dataset determined for the sampling iteration based on an output criterion, wherein the output criterion is based on the third selection value.

2. The method of claim 1, wherein the output criterion comprises determining the bucket dataset as the output dataset corresponding to the sampling iteration for which the summation data file has highest sampling iteration number and minimum standard deviation.

3. The method of claim 1, wherein the first selection value is the quantification value for each of the input data files determined based on an quantification value of each attribute determined based on a probability of occurrence and a probability of absence of each of the attributes in the corresponding input data file.

4. The method of claim 1, wherein the first selection value is a quantification value determined based on cross entropy value and reverse cross-entropy value for each of the input data files, wherein the quantification value is determined based on a desired distribution attribute value for each of the attributes.

5. The method of claim 1, wherein each input data file is associated with a pre-defined counter value, wherein the pre-defined counter value associated to the input data file is decremented when the corresponding input data file is added to the bucket dataset.

6. The method of claim 5, wherein the input data file with highest quantification value and highest counter value is selected to be added to the bucket dataset.

7. A system of creating an output dataset comprising:
one or more processors in a data processing device communicably connected to a memory, wherein the memory stores a plurality of processor-executable instructions which upon execution cause the one or more processors to:
receive a dataset comprising a plurality of input data files,
wherein each input data file comprises attribute values corresponding to a presence of a plurality of attributes;
create a bucket dataset comprising the input data file selected based on a highest first selection value, wherein the first selection value is a quantification value, wherein the quantification value for each of the input data files is determined based on a probability of occurrence of each of the attributes in the corresponding input data file;
iteratively sample the dataset until all input data files of the dataset are added into the bucket list, wherein the iterative sampling for each iteration comprises:
create a subset dataset including subset data files, wherein subset data files are determined based on a summation data file, wherein the summation data file is determined based on summation of attribute values for each of the attributes for each of the input data file of the bucket dataset;
add the summation data file to the summation dataset;
determine a second selection value for each of the subset data files of the subset dataset, wherein the second selection value is a quantification value of each the subset data files determined based on probability of occurrence of each of the attributes in each of the corresponding subset data file; and
add to the bucket dataset the input data file of the updated dataset corresponding to the subset data file with highest second selection value, wherein the dataset is updated by decrementing the input data file added to the bucket dataset;
determine a third selection value for each of the summation data files of the summation dataset; and
determine the output dataset as the bucket dataset determined for the sampling iteration based on an output criterion, wherein the output criterion is based on the third selection value.

8. The system of claim 7, wherein the output criterion is based on determination of the bucket dataset as the output dataset corresponding to the sampling iteration for which the summation data file has highest sampling iteration number and minimum standard deviation.

9. The system of claim 7, wherein the first selection value is the quantification value for each of the input data files determined based on an quantification value of each attribute determined based on a probability of occurrence and a probability of absence of each of the attributes in the corresponding input data file.

10. The system of claim 7, wherein the first selection value is a quantification value determined based on cross quantification value and reverse cross-quantification value for each of the input data files, wherein the quantification value is based on a desired distribution attribute value for each of the attributes.

11. The system of claim 7, wherein each input data file is associated with a pre-defined counter value, wherein the pre-defined counter value associated to the input data file is decremented when the corresponding input data file is added to the bucket dataset.

12. A method of creating an output dataset, the method comprising:
receiving, by one or more processors of a computing device, a dataset from a plurality of data sources, wherein the dataset comprises a plurality of input data files;
wherein each input data file from the plurality of input data files comprises one or more pre-defined attributes;
iteratively sampling the dataset based on a pre-defined type of sampling; and
determining the output dataset based on the pre-defined type of sampling and an output criterion associated to the pre-defined type of sampling, wherein the output dataset comprises a threshold number of input data files and a threshold value of distribution of the input data files for each of the pre-defined attributes.

13. A non-transitory computer-readable medium storing computer-executable instructions for creating an output dataset, the computer-executable instructions configured for:
receiving a dataset comprising a plurality of input data files,
wherein each input data file comprises attribute values corresponding to a presence of a plurality of attributes;
creating a bucket dataset comprising the input data file selected based on a highest first selection value, wherein the first selection value is a quantification value, wherein the quantification value for each of the input data files is determined based on a probability of occurrence of each of the attributes in the corresponding input data file;
iteratively sampling the dataset until all input data files of the dataset are added into the bucket list, wherein the iterative sampling for each iteration comprises:
creating a subset dataset including subset data files, wherein subset data files are determined based on a summation data file, wherein the summation data file is determined based on summation of attribute values for each of the attributes for each of the input data file of the bucket dataset;
adding the summation data file to the summation dataset;
determining a second selection value for each of the subset data files of the subset dataset, wherein the second selection value is a quantification value of each the subset data files determined based on probability of occurrence of each of the attributes in each of the corresponding subset data file; and
adding to the bucket dataset the input data file of the updated dataset corresponding to the subset data file with highest second selection value, wherein the dataset is updated by decrementing the input data file added to the bucket dataset;
determining a third selection value for each of the summation data files of the summation dataset; and
determining the output dataset as the bucket dataset determined for the sampling iteration based on an output criterion, wherein the output criterion is based on the third selection value.

14. The non-transitory computer-readable medium of claim 13, wherein the output criterion comprises determining the bucket dataset as the output dataset corresponding to the sampling iteration for which the summation data file has highest sampling iteration number and minimum standard deviation.

15. The non-transitory computer-readable medium of claim 13, wherein the first selection value is the quantification value for each of the input data files determined based on an quantification value of each attribute determined based on a probability of occurrence and a probability of absence of each of the attributes in the corresponding input data file.

16. The non-transitory computer-readable medium of claim 13, wherein the first selection value is a quantification value determined based on cross entropy value and reverse cross-entropy value for each of the input data files, wherein the quantification value is determined based on a desired distribution attribute value for each of the attributes.

17. The non-transitory computer-readable medium of claim 13, wherein each input data file is associated with a pre-defined counter value, wherein the pre-defined counter value associated to the input data file is decremented when the corresponding input data file is added to the bucket dataset.

18. The non-transitory computer-readable medium of claim 13, wherein the input data file with highest quantification value and highest counter value is selected to be added to the bucket dataset.
